(19) United States
(12) Patent Application Publication
(10) Pub. No.: US 2006/0220440 A1
(43) Pub. Date: Oct. 5, 2006

(54) Wheel and spinning ring assembly

(76) Inventor: Joey W. Treacy, Orlando, FL (US)

Correspondence Address: LITMAN LAW OFFICES, LTD, PO BOX 15035, CRYSTAL CITY STATION, ARLINGTON, VA, 22215, US

(21) Appl. No.: 11/395,171

(22) Filed: Apr. 3, 2006

Related U.S. Application Data
(60) Provisional application No. 60/668,065, filed on Apr. 5, 2005.

(51) Int. Cl. B60B 7/04

(52) U.S. Cl. 301/37.25

(57) ABSTRACT

The wheel and spinning ring assembly is a novelty decorative wheel assembly that includes a wheel having a recessed hub area. The recessed hub area is surrounded by an encircling rim with an exposed opening leading into the recessed hub area. The encircling rim is provided with a groove throughout the entire circumference in the exposed opening leading into the recessed hub area. Attached to the wheel is a spinning ring member. The spinning ring member has a plurality of wheels located along the outer edge, each wheel being adapted to fit and rotate within the groove provided in the exposed opening leading into the recessed hub area. The spinning ring member is adapted to continue rotating after a vehicle has stopped moving, providing a novelty feature while still allowing visual access to the recessed hub area.

### CROSS-REFERENCE TO RELATED APPLICATION

This application claims the benefit of U.S. Provisional Patent Application Ser. No. 60/668,065, filed Apr. 5, 2005.

### BACKGROUND OF THE INVENTION

1. Field of the Invention

The present invention relates to novelty vehicle wheels, and more specifically to a wheel and spinning ring assembly.

2. Description of the Related Art

Decorative novelty wheels, including those with spinning members, for automobiles have been increasingly popular. Spinners provide decorative enhancements for wheels that continue to rotate even after a vehicle has stopped moving. Many of these spinning attachments for wheels are connected to the center of the wheel through the hub area, providing for a central axis of rotation. However, it is becoming more and more popular to have a vehicle with decorative wheel rim and hub features. Unfortunately, one who wants to display a decorative wheel rim or hub and have a spinning enhancement cannot due both due to the fact that the spinner will often cover all, or at least a majority, of the wheel rim and hub.

Accordingly, there is a need for a wheel assembly whereby the user can display both a decorative rim and hub member and provide the wheel with a spinning enhancement.

Thus a wheel and spinning ring assembly solving the aforementioned problems is desired.

### SUMMARY OF THE INVENTION

The wheel and spinning ring assembly includes a wheel having a recessed hub area with openings for receiving studs on a wheel drum. The recessed hub area is defined by an encircling rim having an exposed opening leading into the recessed hub area. The encircling rim is provided with a groove throughout the entire circumference in the exposed opening leading into the recessed hub area.

Attached to the wheel is a spinning ring member having an outer width and a hollow center, the outer width being defined by an outer diameter and an inner diameter. The spinning ring member has a plurality of wheels radially disposed along the outer width, each wheel 5 being adapted to fit and rotate within the groove provided in the exposed opening leading into the recessed hub area. The spinning ring member is a non-load bearing member with a peripheral edge terminating in fixed spaced-apart relationship with respect to the encircling rim. The spinning ring member is adapted to continue rotating after a vehicle has 10 stopped moving, providing a novelty feature while still allowing visual access to the recessed hub area.

These and other features of the present invention will become readily apparent upon further review of the following specification and drawings.

### BRIEF DESCRIPTION OF THE DRAWINGS

FIG. 1 is an front, environmental view of a wheel and spinning ring assembly according to the present invention.

FIG. 2 is a perspective view of a wheel with a recessed hub area and encircling rim defining an exposed opening leading into the recessed hub area according to the present invention.

FIG. 3 is a cross-sectional side view of a wheel and spinning ring assembly according to the present invention.

FIG. 4 is an enlarged, exploded view of a wheel mounting according to the present invention.

FIG. 5 is a back view of a spinning ring member according to the present invention.

Similar reference characters denote corresponding features consistently throughout the attached drawings.

### DETAILED DESCRIPTION OF THE PREFERRED EMBODIMENTS

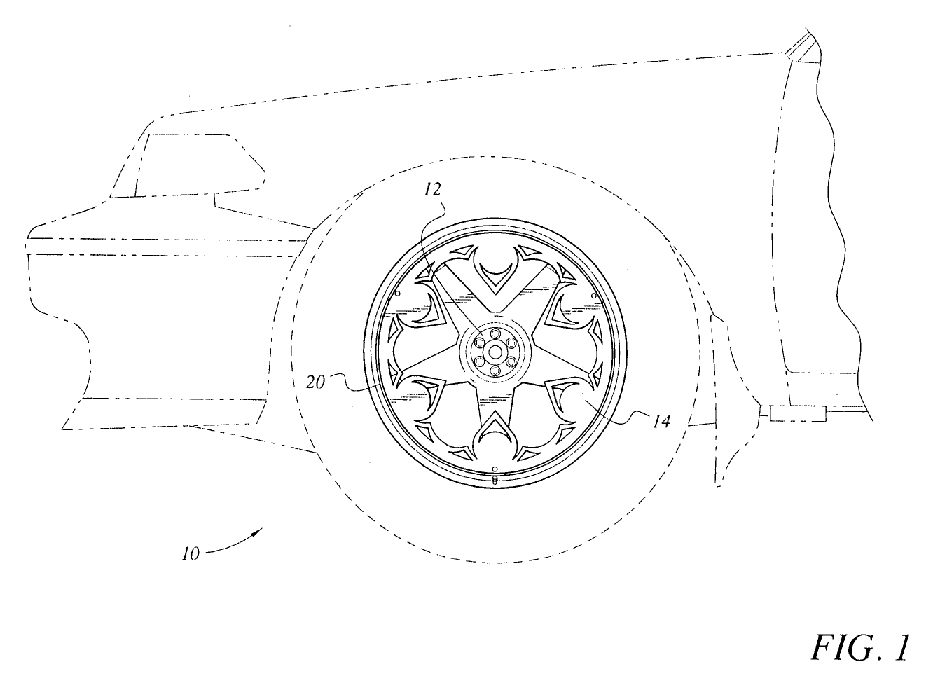

The present invention is a wheel and spinning ring assembly, of which a preferred embodiment is designated generally as 10 in FIG. 1. 15 Wheel and spinning ring assembly 10 includes a wheel with recessed hub area 12 and encircling rim 20. Spinning ring member 14 engages with encircling rim 20 and provides a spinning motion while still allowing visual access of the recessed hub area 12. As seen, spinning ring member 14 can be provided with a decorative design to enhance the visual appeal.

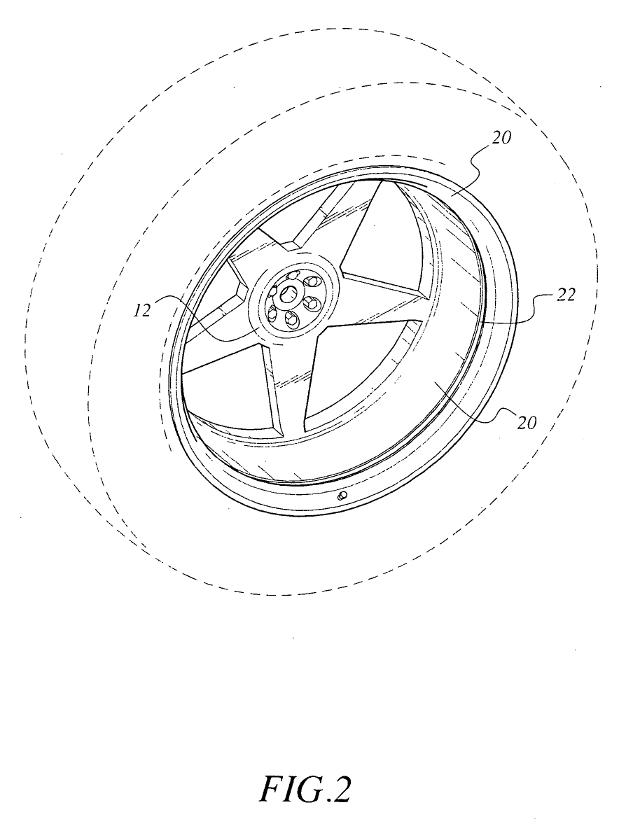

FIG. 2 shows a wheel with recessed hub area 12 and encircling rim 20. Encircling rim 20 defines an exposed opening leading into recessed hub area 12. Groove 22 is located in the exposed opening area defined by encircling rim 20 and encompasses the entire exposed opening area.

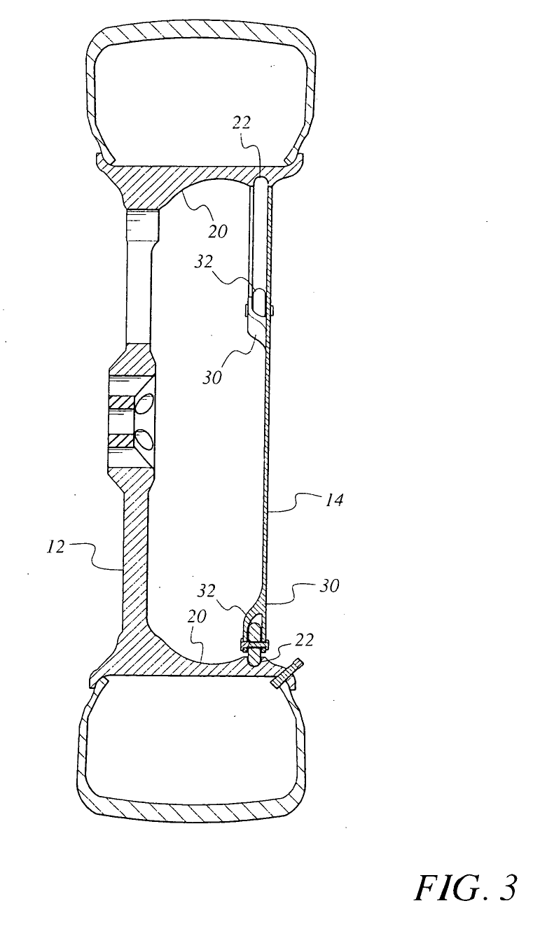

Turning now to FIG. 3, spinning ring member 14 is shown in an engaged position with the wheel. Spinning ring member 14 rotates relative to encircling rim 20 through the use of skate wheels 32 that run in groove 22. Skate wheels 32 are disposed on the recessed hub-facing side of spinning ring member 14 along the periphery of spinning ring member 14 and held in place with brackets 30. Spinning ring member 14 is a non-load bearing member with a peripheral edge terminating in fixed spaced-apart relationship with respect to encircling rim 20. As the wheel turns with the vehicle in motion, the spinning ring member 14 rotates relative to the encircling rim 20 and recessed hub 12. After the vehicle is stopped, retained momentum in spinning ring member 14 will allow it to continue to rotate for a limited period of time.

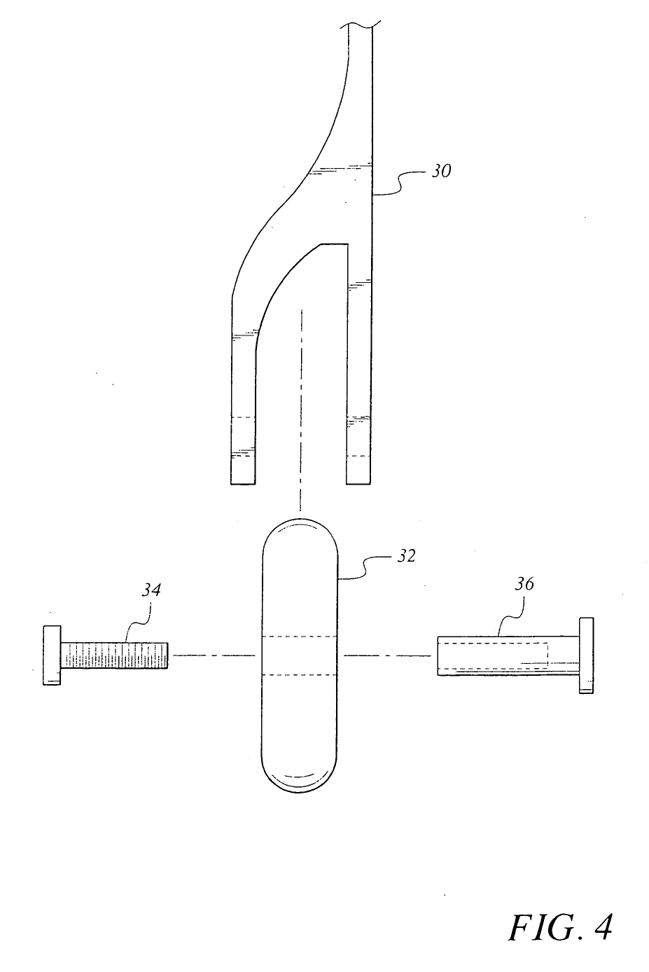

FIG. 4 shows an enlarged view of bracket 30 used for retaining a skate wheel 32 in place. Bracket 30 is provided with a pair of apertures corresponding with the inner diameter of skate wheel 32. Skate wheel 32 is secured to the bracket with the use of a screw 34 and retainer screw 36 combination. When combined to secure skate wheel 32 to bracket 30, screw 34 and retainer screw 36 provide an axle for skate wheel 32 to rotate about. Screw 32 is accessible from the rear of the assembly and can be loosened in order to remove skate wheel 32. Once one or more of the skate wheels 32 have been removed from any given assembly, the spinning ring member may be removed from the wheel. In this manner, different spinning ring members can be interchanged, providing a convenient way for the user to change the decorative appeal of the vehicle's wheels.

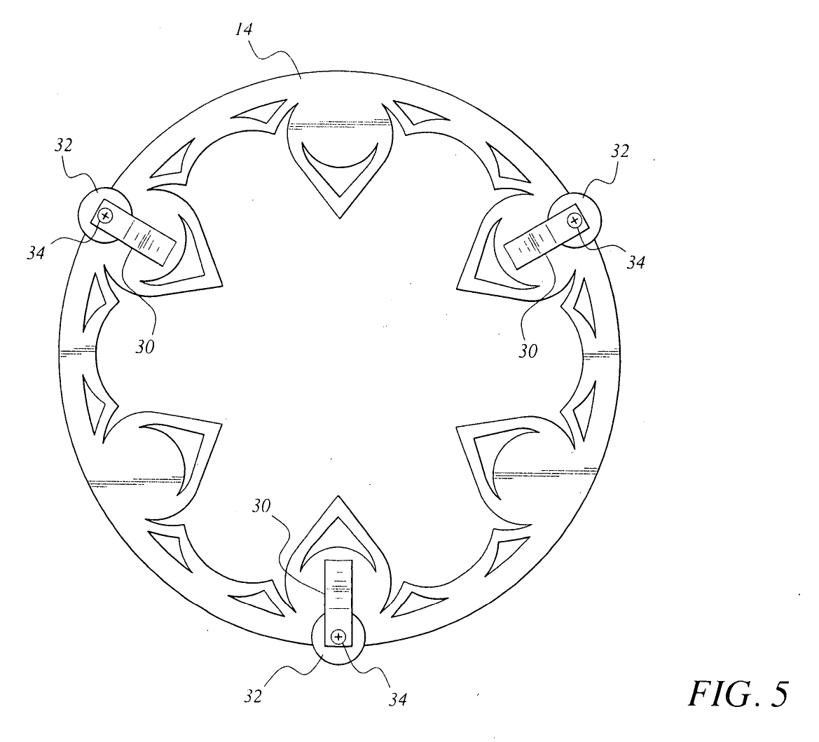

FIG. 5 shows the back side of spinning ring member 14 with attached brackets 30 and engaged skate wheels 32. In the preferred embodiment, spinning ring member 14 is provided with three brackets 30 and three corresponding skate wheels 32. In this manner, only a single screw 34 on one of the skate wheels 32 must be loosened and removed in order to facilitate the removal of the entire spinning ring member 14.

It is to be understood that the present invention is not limited to the embodiments described above, but encompasses any and all embodiments within the scope of the following claims.

I claim:

1. A wheel and spinning ring assembly, comprising:
a wheel having a recessed hub area with openings for receiving studs on a wheel drum, the recessed hub area defined by an encircling rim defining an exposed opening leading into the recessed hub area, the encircling rim being provided with a groove throughout the entire circumference in the exposed opening leading into the recessed hub area; and
a spinning ring member having an outer width and a hollow center, the outer width defined by an outer diameter and an inner diameter, the spinning ring member being provided with a plurality of skate wheels radially disposed along the outer width, each skate wheel being adapted to fit and rotate within the groove provided in the exposed opening leading into the recessed hub area, the spinning ring member being non-load bearing with a peripheral edge terminating in fixed spaced-apart relationship with respect to the encircling rim.

2. The wheel and spinning ring assembly according to claim 1, further comprising a series of brackets, each bracket being radially disposed along the outer width of the spinning ring member for retaining a skate wheel, the skate wheel being attached to the bracket with a screw and retainer screw combination, the screw and retainer screw combination providing an axle of rotation for the skate wheel.

3. The wheel and spinning ring assembly according to claim 1, wherein the inner diameter of the spinning ring member varies providing the outer width of the spinning ring member with a decorative look.

4. The wheel and spinning ring assembly according to claim 3, wherein a plurality of decorative cut-outs are provided in the outer width of the spinning ring member.

5. A wheel and spinning ring assembly, comprising:
a wheel having a recessed hub area with openings for receiving studs on a wheel drum, the recessed hub area defined by an encircling rim defining an exposed opening leading into the recessed hub area, the encircling rim being provided with a groove throughout the entire circumference in the exposed opening leading into the recessed hub area;
a spinning ring member having an outer width and a hollow center, the outer width defined by an outer diameter and an inner diameter, the spinning ring member being provided with a plurality of skate wheels radially disposed along the outer width, each skate wheel being adapted to fit and rotate within the groove provided in the exposed opening leading into the recessed hub area, the spinning ring member being non-load bearing with a peripheral edge terminating in fixed spaced-apart relationship with respect to the encircling rim; and
a series of brackets, each bracket being radially disposed along the outer width of the spinning ring member for retaining a skate wheel, the skate wheel being attached to the bracket with a screw and retainer screw combination, the screw and retainer screw combination providing an axle of rotation for the skate wheel.

6. The wheel and spinning ring assembly according to claim 5, wherein the inner diameter of the spinning ring member varies providing the outer width of the spinning ring member with a decorative look.

7. The wheel and spinning ring assembly according to claim 6, wherein a plurality of decorative cut-outs are provided in the outer width of the spinning ring member.
